(19) United States
(12) Patent Application Publication
(10) Pub. No.: US 2025/0279434 A1
(43) Pub. Date: Sep. 4, 2025

(54) POSITIVE ELECTRODE ADDITIVE FOR LITHIUM SECONDARY BATTERY AND METHOD OF PREPARING SAME

(71) Applicants: Hyundai Motor Company, Seoul (KR); Kia Corporation, Seoul (KR); University-Industry Cooperation Group of Kyung Hee University, Yongin (KR)

(72) Inventors: Chang Hoon Song, Seoul (KR); Sang Hun Lee, Paju (KR); Tae Ho Park, Hwaseong (KR); Eung Ju Lee, Daejeon (KR); Seung Tae Kim, Yongin (KR); Soo Young Yang, Seoul (KR); Ki Min Kwon, Cheonan (KR); Seung Min Oh, Incheon (KR); Ki Kang Lee, Hwaseong (KR); Yun Seong Byeon, Seoul (KR); Min Jae You, Yongin (KR); Min Sik Park, Suwon (KR)

(21) Appl. No.: 18/939,284

(22) Filed: Nov. 6, 2024

(30) Foreign Application Priority Data
Feb. 29, 2024 (KR) 10-2024-0030036

(51) Int. Cl. H01M 4/62; B60R 16/033; C01G 53/00; H01M 4/36; H01M 10/0525

(52) U.S. Cl. CPC H01M 4/628; B60R 16/033; C01G 53/42; H01M 4/366; H01M 10/0525; C01P 2002/50; C01P 2002/72; C01P 2002/82; C01P 2002/85; C01P 2004/03; C01P 2004/80; C01P 2006/40; H01M 2220/20

(57) ABSTRACT

Provided is a positive electrode additive containing an excess of lithium, the positive electrode additive being capable of demonstrating the inherent effect thereof when exposed to air through the coating of the surface of the positive electrode additive with a hydrophobic material and an ion-conductive material to achieve the effects of preventing the formation of impurities such as Li₂CO₃, LiOH, and the like generated on the surface of the positive electrode additive when left in air.

### CROSS REFERENCE TO RELATED APPLICATIONS

The present application claims under 35 U.S.C. § 119(a) the benefit of Korean Patent Application No. 10-2024-0030036, filed on Feb. 29, 2024, the entire contents of which is incorporated herein for all purposes by this reference.

### BACKGROUND

### Technical Field

The present disclosure relates to a positive electrode additive containing an excess of lithium. The positive electrode additive is capable of demonstrating the inherent effect thereof when exposed to air through the coating of the surface of the positive electrode additive with a hydrophobic material and an ion-conductive material. This coating prevents the formation of impurities such as Li₂CO₃, LiOH, and similar substances generated on the surface of the positive electrode additive when left in air.

### Background

Various graphite-based materials that enable intercalation/deintercalation of lithium are used as negative electrode active materials for lithium secondary batteries. However, the theoretical capacity of such graphite-based materials is low (372 mAh/g), making it challenging to obtain cells with high energy density. As a result, extensive research is underway on silicon oxide or transition metal oxide negative electrode materials capable of achieving high theoretical capacity. However, such these electrode active materials exhibit an initial charge loss of about 30% after the first charge due to high irreversibility during early-stage charging, which is problematic.

To solve such a problem, various studies on positive electrode additives applied to overcome the irreversible capacity loss of negative electrodes have been proposed. Specifically, there is a method of applying Li₂NiO₂ or Li₂CuO₂ positive electrode additive containing an excess of lithium to the positive electrode.

Positive electrode additives containing an excess of lithium can react with moisture or carbon dioxide in air without difficulty, thus forming a large amount of impurities such as Li₂CO₃ and LiOH on the surface of the particles. These lithium residues on such a surface generate gas through side reactions with electrolytes, leading to a deterioration in electrochemical properties.

The foregoing is intended merely to aid in the understanding of the background of the present disclosure and is not intended to mean that the present disclosure falls within the purview of the related art that is already known to those skilled in the art.

### SUMMARY

In one aspect, the present disclosure aims to provide a positive electrode additive containing an excess of lithium, the positive electrode additive being capable of improving electrochemical properties by achieving the effects of reducing or preventing the formation of impurities such as Li₂CO₃, LiOH, and the like generated on the surface of the positive electrode additive when exposed to air, a method of preparing the same, a positive electrode including the same, and a lithium secondary battery.

Technical problems to be solved by the present disclosure are not limited to the technical problems mentioned above, and it will be apparent that other technical problems not mentioned can be clearly understood by those skilled in the art from the description of the present disclosure.

In one aspect, a positive electrode additive for a lithium secondary battery of the present disclosure, which has been made to solve such a problem, includes: a core component comprising a lithium metal oxide; and a coating layer containing a hydrophobic material and an ion-conductive material, the coating layer coating the surface of the core component.

For example, the lithium metal oxide contained in the core component may be characterized by being a compound represented by Formula 1 and having an orthorhombic crystal structure.

Li₂NiₓCu_{y}O₂ (where 0≤x≤1, 0≤y≤1, and x+y=1) [Formula 1]

For example, the hydrophobic material contained in the coating layer may be characterized by being a compound represented by Formula 2.

CH₃[Si(CH₃)₂O]ₙOSi(CH₃)₃(polydimethylsiloxane, PDMS) [Formula 2]
(where n is an integer in a range of 1 to 1000)

For example, the ion-conductive material contained in the coating layer may be characterized by being a compound represented by Formula 3.

Me₂O₃ [Formula 3]

In this case, Me is a metal element selected from the group consisting of boron (B) and aluminum (Al), the metal element being capable of forming a trivalent cation during oxidation.

For example, the coating layer contained in the positive electrode additive may be characterized by accounting for 10 wt % or less (excluding 0 wt %) based on the total weight of the positive electrode additive.

For example, a weight ratio of the hydrophobic material represented by Formula 2 to the ion-conductive material represented by Formula 3, contained in the coating layer, may be characterized by being in a range of 7:3 to 5:5.

For example, when performing Fourier-transform infrared spectroscopy (FTIR) measurement, the positive electrode additive may be characterized by exhibiting the following peaks: a first peak in the region of 790 to 810 cm⁻¹, a second peak in the region of 910 to 930 cm⁻¹, a third peak in the region of 1020 to 1100 cm⁻¹, a fourth peak in the region of 1110 to 1130 cm⁻¹, a fifth peak in the region of 1200 to 1250 cm⁻¹, a sixth peak in the region of 1340 cm⁻¹, and a seventh peak in the region of 1370 to 1390 cm⁻¹.

For example, when performing X-ray photoelectron spectroscopy (XPS) analysis on a B is region, the positive electrode additive may be characterized by exhibiting a third peak in the region of 292.20 to 292.27 eV

For example, when performing XPS analysis on a Si 2p region, the positive electrode additive may be characterized by exhibiting a first peak in the region of 101.7 to 101.9 eV and a second peak in the region of 103.2 to 103.3 eV

For example, when performing Raman spectrum analysis, the positive electrode additive may be characterized by exhibiting a first peak in the region of 700 to 750 cm⁻¹ and a second peak in the region of 780 to 820 cm⁻¹.

A method of preparing a positive electrode additive for a lithium secondary battery of the present disclosure, which has been made to solve such a problem, includes: preparing a core component containing lithium metal oxide; and forming a coating layer containing a hydrophobic material and an ion-conductive material, the coating layer coating the surface of the core component.

For example, the lithium metal oxide contained in the core component may be characterized by being a compound represented by Formula 1 and in preferred aspects having an orthorhombic crystal structure.

Li₂NiₓCu_{y}O₂ (where 0≤x≤1, 0≤y≤1, and x+y=1) [Formula 1]

For example, the hydrophobic material contained in the coating layer may be characterized by being a compound represented by Formula 2.

CH₃[Si(CH₃)₂O]ₙOSi(CH₃)₃(polydimethylsiloxane, PDMS) [Formula 2]
(where n is an integer in a range of 1 to 1000)

For example, the ion-conductive material contained in the coating layer may be characterized by being a compound represented by Formula 3.

Me₂O₃ [Formula 3]

In this case, Me is a metal element selected from the group consisting of boron (B) and aluminum (Al), the metal element being capable of forming a trivalent cation during oxidation.

For example, in one aspect, the preparing of the core component may be characterized in that a pellet is obtained by applying a pressure to any one among a lithium composite metal oxide, lithium hydroxide, or a mixture thereof, and the obtained pellet then is subjected to heat treatment.

For example, in one aspect or preferred protcol, the heat treatment may be characterized by being performed at a temperature in a range of 500° C. to 800° C. for 16 to 18 hours.

For example, in one aspect, the forming of the coating layer may be characterized in that a sintered product is formed by introducing the hydrophobic material represented by Formula 2, the ion-conductive material represented by Formula 3, and the core component containing the lithium metal oxide represented by Formula 1 admied in one or more suitablt solvents such as tetrahydrofuran (THF) or other organic solvent, stirring the resulting mixture, removing (e.g. evaporating) the solvent such as THF solvent, and subjecting unevaporated residues to heat treatment, and then the sintered product is cooled to room temperature and ground.

For example, in one aspect, the heat treatment may be characterized by being performed in a vacuum atmosphere at a temperature in a range of 150° C. to 200° C. for 5 to 7 hours.

For example, in one aspect, the forming of the coating layer may be characterized by being performed in such a manner that the coating layer contained in the positive electrode additive accounts for 0.1 to 20 wt % based on the total weight of the positive electrode additive.

For example, in one aspect, the forming of the coating layer may be characterized by being performed in such a manner that a weight ratio of the hydrophobic material represented by Formula 2 to the ion-conductive material represented by Formula 3, contained in the coating layer, is in a range of 7:3 to 5:5.

In preferred aspects, with the use of a positive electrode additive having atmospheric stability characteristics according to the present disclosure, the formation of lithium impurities such as Li₂CO₃, LiOH, and the like generated on the surface of the positive electrode additive can be reduced. Accordingly, a lithium secondary battery using the positive electrode additive of the present disclosure can achieve low capacity loss and excellent electrochemical properties when left in air.

In additional aspects, a lithium secondary battery is provided comprising a lithium battery additive as disclosed herein. The battery may be for example lithium ion secondary battery or a lithium ion primary battery. In preferred aspects, the battery is a lithium secondary battery.

In yet additional aspects, vehicle are provided that comprising a lithium secondary battery additive and/or battery (including lithium secondary battery) as disclosed herein.

Effects that can be achieved by the present disclosure are not limited to the effect mentioned above, and other effects that are not mentioned above but can be achieved by the present disclosure can be clearly understood by those skilled in the art from the description below.

### BRIEF DESCRIPTION OF THE DRAWINGS

FIG. 1 is a diagram illustrating the structural formula of CH₃[Si(CH₃)₂O]OSi(CH₃)₃(polydimethylsiloxane, PDMS) (where n is an integer in a range of 1 to 1000) contained in a positive electrode additive for a lithium secondary battery of the present disclosure;

FIG. 2 is a diagram showing a method of preparing a positive electrode additive for a lithium secondary battery of the present disclosure;

FIG. 3 is a graph showing the results of X-ray diffraction (XRD) analysis performed on Comparative Examples 1 to 4 and Examples 1 to 2;

FIG. 4 is a graph showing the results of Fourier-transform infrared spectroscopy (FTIR) analysis performed on Comparative Examples 1 to 4 and Examples 1 to 2;

FIG. 5 is a graph showing the results of Raman spectrum analysis performed on Comparative Examples 1 to 4 and Examples 1 to 2;

FIG. 6 to FIG. 11 are graphs showing the results of X-ray photoelectron spectroscopy (XPS) analysis performed on the Si 2p regions of Comparative Examples 1 to 4 and Examples 1 to 2;

FIG. 12 to FIG. 17 are graphs showing the results of XPS analysis performed on the B is regions of Comparative Examples 1 to 4 and Examples 1 to 2;

FIG. 18 to FIG. 29 are images of Comparative Examples 1 to 4 and Examples 1 to 2, the images taken by scanning electron microscopy (SEM);

FIG. 30 to FIG. 35 are graphs showing measurement results of the distribution of Si and B elements through energy-dispersive spectroscopy (EDS) analysis performed on materials prepared in Comparative Examples 1 to 4 and Examples 1 to 2;

FIG. 36 is a graph showing the results of electrochemical property evaluation performed on Comparative Examples 1 to 4 and Examples 1 to 2;

FIG. 37 is a graph showing the results of impedance analysis performed on Comparative Examples 1 to 4 and Examples 1 to 2;

FIG. 38 is a graph showing the results of electrochemical property evaluation performed on Comparative Examples 1 to 4 and Examples 1 to 2 after being left in air at a relative humidity of 40% for 12 hours;

FIG. 39 is a graph showing the results of electrochemical property evaluation performed on Comparative Examples 1 to 4 and Examples 1 to 2 after being left in air at a relative humidity of 40% for 24 hours;

FIG. 40 is a graph showing the results of electrochemical property evaluation performed on Comparative Examples 1 to 4 and Examples 1 to 2 after being left in air at a relative humidity of 40% for 48 hours;

FIG. 41 is a graph showing the results of electrochemical property evaluation performed on Comparative Examples 1 to 4 and Examples 1 to 2 after being left in air at a relative humidity of 40% for 60 hours;

FIG. 42 is a graph showing the results of X-ray diffraction (XRD) analysis measurement performed on Comparative Examples 1 to 4 and Examples 1 to 2 after being left in air at a relative humidity of 40% for 48 hours;

FIG. 43 is a graph showing the results of measurement performed on lithium residues (LiOH and Li₂CO₃) through electrochemical titration for Comparative Examples 1 to 4 and Examples 1 to 2 after being left in air at a relative humidity of 40% for 48 hours; and

FIG. 44 to FIG. 49 are graphs showing the results of real-time PAT-cell gas electrochemical property evaluation of and gas generation measurement performed on Comparative Examples 1 to 4 and Examples 1 to 2.

### DETAILED DESCRIPTION

While present disclosure may be variously modified and have various embodiments, specific embodiments will be illustrated in the drawings and described in detail. However, this is not intended to limit the embodiments according to the concept of the present disclosure to a specific disclosed form and should be understood to include all modifications, equivalents, or substitutes included in the spirit and technical scope of the present disclosure.

Terms used herein are only used to describe specific embodiments and are not intended to limit the present disclosure. As used herein, the singular forms “a”, “an”, and “the” are intended to include the plural forms as well unless the context clearly indicates otherwise. It will be further understood that the terms “comprises”, “includes”, or “has” when used herein specify the presence of stated features, regions, integers, steps, operations, elements, and/or components, but do not preclude the presence or addition of one or more other features, regions, integers, steps, operations, elements, components, and/or combinations thereof.

In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. In certain aspects, the vehicle is an electric vehicle which is inclusive of plug-in hybrid electric vehicles.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

“A range of X to Y” or “ranging from X to Y” described herein should be interpreted as including all numbers between X and Y As one example, a range of 1 to 10 described should be interpreted as including not only 1 and 10 but also the numbers in between, that is, both integers and decimals.

Unless otherwise defined, all terms used herein, including technical or scientific terms, have the same meaning as commonly understood by those skilled in the art to which the present disclosure pertains. It will be further understood that terms, such as those defined in commonly used dictionaries, should be interpreted as having a meaning that is consistent with their meaning in the context of the related art and the present disclosure and will not be interpreted in an idealized or overly formal sense unless expressly so defined herein.

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments. On the contrary, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

X-ray diffraction (XRD) analysis, a technique used in materials science to determine the atomic and molecular structure of materials, enables not only the measurement of the average position of atoms in the crystals of a sample by irradiating a sample with X-rays and measuring the peak of the scattering angles and intensity of the X-rays scattered by the sample but also the determination of how the actual structure deviates from the ideal structure. Specifically, an XRD meter purchased from Thermo Fisher Scientific Inc., an ARL EQUINOX 3000 model, may be used for the measurement. In addition to the device mentioned above, devices used in the related industry may be appropriately employed.

Raman spectroscopy, based on the Raman effect, is an experimental method of measuring the surface condition of a molecule through a phenomenon in which when a specific molecule is irradiated with a laser beam, the energy corresponding to a difference in the energy level of the electrons of the molecule is absorbed, thereby determining the degree of crushing of the sample. Specifically, a Raman spectrometer (ReactRaman 802L purchased from METTLER TOLEDO. Inc.) may be used for the measurement.

X-ray photoelectron spectroscopy (XPS) is an experimental method of measuring the intensity and kinetic energy of photoelectrons emitted by the photoelectric effect when X-rays are incident on a sample. This technique determines the bonding properties and constituents on the surface thereof. For example, an XPS meter such as Nexsa G2 Surface Analysis System purchase from Thermo Fisher Scientific Inc. may be used for this measurement. In addition to the device mentioned above, other devices commonly used in the related industry may be appropriately employed.

Fourier-transform infrared spectroscopy (FTIR) analysis is an experimental method of measuring the characteristic infrared spectrum of a molecule through irradiation with light in the infrared region of the molecule to absorb light at the unique vibrational frequency required to cause bond vibrations. Each bonding structure between the constituent elements of the molecule has a unique value, so this may demonstrate the bonding structure between the constituent elements of the molecule. Specifically, an IR spectrometer, an INVENIO model purchased from Bruker Inc., may be used for the measurement. In addition to the device mentioned above, devices used in the related industry may be appropriately employed.

Energy-dispersive spectroscopy (EDS) analysis is an analytical technique that enables chemical characterization and elemental analysis of materials. When a sample is stimulated by an energy source, such as an electron beam of an electron microscope, it emits core component-shell electrons, releasing some of the absorbed energy. Then, outer-shell electrons with higher energy fill the place of the emitted core component-shell electrons, and the energy difference is released as X-rays with a characteristic spectrum based on the atomic origin. This allows for the composition of a given sample volume stimulated by the energy source to be analyzed. The position of each peak in the spectrum identifies an element, and the signal intensity indicates the concentration of the element. Specifically, a Spectra Ultra model purchased from Thermo Fisher Scientific Inc. may be used. In addition to the device mentioned above, other devices commonly used in the related industry may also be appropriately employed.

The present disclosure relates to a positive electrode additive containing an excess of lithium, the positive electrode additive being capable of demonstrating the inherent effect thereof when exposed to air through the coating of the surface of the positive electrode additive with a hydrophobic material and an ion-conductive material to achieve the effects of preventing the formation of impurities such as Li₂CO₃, LiOH, and the like generated on the surface of the positive electrode additive when left in air, and to a method of preparing the same. Additionally, the present disclosure relates to a positive electrode for a lithium secondary battery, the positive electrode being capable of achieving low capacity loss and excellent electrochemical properties even when left in air by containing a positive electrode additive with such atmospheric stability, and to a lithium secondary battery.

A positive electrode additive for a lithium secondary battery of the present disclosure includes: a core component containing a lithium metal oxide; and a coating layer containing a hydrophobic material and an ion-conductive material, the coating layer coating the surface of the core component,

In this case, the lithium metal oxide contained in the core component may be characterized by being a compound represented by Formula 1 and having an orthorhombic crystal structure.

Li₂NiₓCu_{y}O₂ (where 0≤x≤1, 0≤y≤1, and x+y=1) [Formula 1]

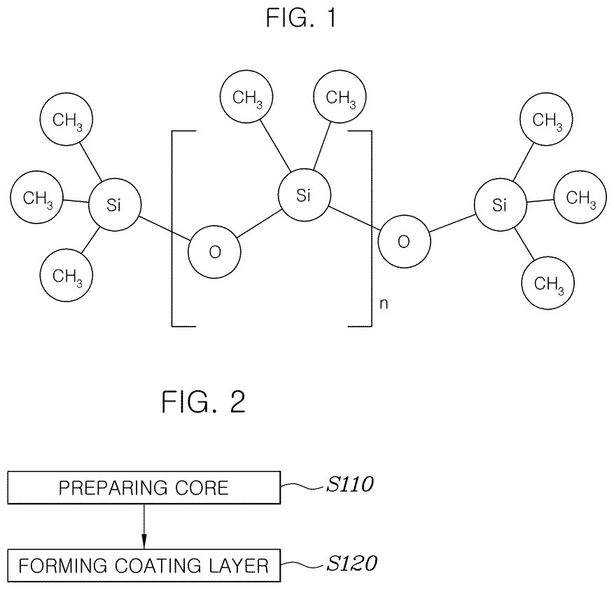

Additionally, the hydrophobic material contained in the coating layer may be a compound represented by Formula 2, and the structural formula thereof may be as shown in FIG. 1.

CH₃[Si(CH₃)₂O]ₙOSi(CH₃)₃(polydimethylsiloxane, PDMS) [Formula 2]
(where n is an integer in a range of 1 to 1000)

The ion-conductive material contained in the coating layer may be characterized by being a compound represented by Formula 3.

Me₂O₃ [Formula 3]

In this case, Me is a metal element selected from the group consisting of boron (B) and aluminum (Al), the metal element being capable of forming a trivalent cation during oxidation.

Specifically, the ion-conductive material may be B₂O₃.

On the other hand, the coating layer contained in the positive electrode additive may account for 10 wt % or less (excluding 0 wt %) and preferably accounts for 5 wt % or less (excluding 0 wt %), based on the total weight of the positive electrode additive. Additionally, the weight ratio of the hydrophobic material represented by Formula 2 to the ion-conductive material represented by Formula 3, contained in the coating layer, may be in a range of 5:5 to 7:3.

This is because, within the above numerical ranges, the positive electrode additive for the lithium secondary battery of the present disclosure may have excellent capacity retention effects, reduced interfacial resistance due to high ionic conductivity, and excellent atmospheric stability in high-humidity environments. These benefits will be confirmed in the examples, comparative examples, and experimental examples described later.

Additionally, when performing Fourier-transform infrared spectroscopy (FTIR) measurement, the positive electrode additive of the present disclosure may exhibit the following peaks: a peak in the region of 1020 to 1100 cm⁻¹, a peak in the region of 1200 to 1250 cm⁻¹, and a peak in the region of 790 to 810 cm⁻¹ due to PDMS. Furthermore, as B₂O₃ is used for doping, the following peaks may be exhibited: a peak in a region of 910 to 930 cm⁻¹, a peak in the region of 1370 to 1390 cm⁻¹, a peak in the region of 1110 to 1130 cm⁻¹, and a peak in the region of 1340 cm⁻¹ corresponding to the Si—O—B bond.

On the other hand, when performing Raman spectroscopy measurement, the positive electrode additive of the present disclosure may exhibit the following peaks in a Raman shift region: a peak in the region of 700 to 750 cm⁻¹ corresponding to the Si—O bond and a peak in the region of 780 to 820 cm⁻¹ corresponding to the B—O bond.

Additionally, when performing X-ray photoelectron spectroscopy analysis on the B is region, the positive electrode additive of the present disclosure may exhibit the following peaks: a peak due to photoelectrons with energy in the region of 101.7 to 101.9 eV corresponding to the Si—O—Si bond, a peak due to photoelectrons with energy in the region of 103.2 to 103.3 eV corresponding to the O—Si—O bond, and a peak due to photoelectrons with energy in the region of 292.20 to 292.27 eV corresponding to the B—O bond.

A positive electrode active material of the present disclosure will be further described.

The compound represented by Formula 1, contained in the core component of the present disclosure, contains an excess of lithium. The compound containing such an excess of lithium may react with moisture or carbon dioxide in air without difficulty and thus form impurities such as Li₂CO₃ and LiOH on the surface of the particles as follows.

2Li⁺+CO₃²⁻→Li₂CO₃ [Chemical Equation 1]

Li⁺+OH⁻→LiOH [Chemical Equation 2]

In this case, the impurities formed may cause side reactions with the electrolyte, generating gas and other by-products, leading to deterioration of the performance of the lithium secondary battery containing them.

However, the positive electrode additive of the present disclosure contains a hydrophobic material represented by Formula 2 and an ion-conductive material represented by Formula 3 on the surface, thereby forming a coating layer positioned on the surface of the core component.

The hydrophobic material contained in the coating layer may effectively prevent the formation of the impurities described above by blocking the reaction of the core component containing the excess of lithium with moisture and carbon dioxide in air. Additionally, the ion-conductive material contained in the coating layer allows lithium to be effectively released, enabling the positive electrode additive to demonstrate the inherent effect thereof.

FIG. 2 is a diagram showing a method of preparing the positive electrode additive for the lithium secondary battery of the present disclosure. With reference to FIG. 2, the method of preparing the positive electrode additive for the lithium secondary battery of the present disclosure will be described.

First, a step of preparing a core component containing lithium metal oxide may be performed (S110).

In this case, the lithium metal oxide contained in the core component may be characterized by being a compound represented by Formula 1 and having an orthorhombic crystal structure.

Li₂NiₓCu_{y}O₂ (where 0≤x≤1, 0≤y≤1, and x+y=1) [Formula 1]

In this case, in the method of preparing the core component, a pellet may be obtained by applying a pressure to any one among a lithium composite metal oxide, lithium hydroxide, or a mixture thereof and then subjecting it to heat treatment to prepare the core component.

The heat treatment may be performed at a temperature in a range of 500° C. to 800° C. for 16 to 18 hours.

Specifically, a powdered positive electrode additive may be obtained by mixing 1.0 mole of Li₂O and 1.0 mole of NiOH, maintaining 4 tons of pressure for 5 minutes using a pelletizer to obtain a pellet, heating the obtained pellet to a temperature of 710° C. at a rate of 5° C. per minute in a sintering furnace, maintaining the same temperature for 17 hours, and cooling the resulting sintered product for grinding.

Next, a step of forming a coating layer containing a hydrophobic material and an ion-conductive material, the coating layer coating the surface of the core component, may be performed (S120).

In this case, the hydrophobic material contained in the coating layer may be a compound represented by Formula 2, and the structural formula thereof may be as shown in FIG. 1.

CH₃[Si(CH₃)₂O]ₙOSi(CH₃)₃(polydimethylsiloxane, PDMS) [Formula 2]
(where n is an integer in a range of 1 to 1000)

Additionally, the ion-conductive material contained in the coating layer may be characterized by being a compound represented by Formula 3.

Me₂O₃ [Formula 3]

In this case, Me is a metal element selected from the group consisting of boron (B) and aluminum (Al), the metal element being capable of forming a trivalent cation during oxidation.

Specifically, the ion-conductive material may be B₂03.

In this case, the coating layer contained in the positive electrode additive may be set to account for 10 wt % or less (excluding 0 wt %), and preferably 5 wt % or less (excluding 0 wt %), based on the total weight of the positive electrode additive.

Additionally, the weight ratio of the hydrophobic material represented by Formula 2 to the ion-conductive material represented by Formula 3, contained in the coating layer, may be set to be in a range of 7:3 to 5:5.

This is because, within the above numerical ranges, the positive electrode additive for the lithium secondary battery of the present disclosure may have excellent capacity retention effects, reduced interfacial resistance due to high ionic conductivity, and excellent atmospheric stability in high-humidity environments, as will be confirmed in examples, comparative examples, and experimental examples to be described later.

Additionally, the step of forming the coating layer may involve introducing PDMS and B(OH)₃ into a tetrahydrofuran (THF) solvent and stirring the resulting mixture for a predetermined time, introducing the core component into the THF solvent and stirring the resulting mixture, evaporating the THF solvent, subjecting unevaporated residues to heat treatment, and then cooling the resulting sintered product obtained through the heat treatment to room temperature for grinding.

In this case, the heat treatment may be performed in a vacuum atmosphere at a temperature in a range of 150° C. to 200° C. for 5 to 7 hours.

Specifically, PDMS, the hydrophobic material, and B(OH)₃, the ion-conductive material, may be introduced into the THF solvent in a weight ratio in a range of 7:3 and then stirred. In this case, the total weight of PDMS, the hydrophobic material, and B(OH)₃, the ion-conductive material, constituting the core component coating layer may be 5 wt % compared to the core component. Next, the resulting mixture may be stirred at a speed of 400 rpm for 1 hour, and then the THF solvent may be removed by evaporation. The remaining product may be subjected to the heat treatment at a temperature of 150° C. in a vacuum oven to form a sintered product. Then, the sintered product may be cooled to room temperature and ground to obtain the positive electrode additive of the present disclosure.

Additionally, a positive electrode for the lithium secondary battery of the present disclosure and the lithium secondary battery may include the positive electrode additive for the lithium secondary battery of the present disclosure.

### <Positive Electrode>

A positive electrode material may be obtained by mixing the positive electrode active material, a conductive additive, and a binder. The positive electrode material may be applied on a positive electrode current collector to form a positive electrode. The positive electrode current collector may be a conductor. The application of the positive electrode material onto the positive electrode current collector may involve making a paste using compression molding or an organic solvent, and then applying and pressing the paste onto the current collector for fixation.

### <Negative Electrode>

A negative electrode active material may also be formed using materials capable of enabling the deintercalation of lithium ions or causing conversion reactions.

A negative electrode material may be obtained by mixing the negative electrode active material, a conductive additive, and a binder.

The negative electrode material may be applied on a negative electrode current collector to form a negative electrode. The negative electrode current collector may be a conductor. The application of the negative electrode material on the negative electrode current collector may involve a method of making a paste using compression molding or an organic solvent and then applying and pressing the paste on the current collector for fixation.

### <Electrolyte>

An electrolyte may contain lithium. Additionally, an electrolyte containing fluorine may be used. Furthermore, the electrolyte may be dissolved in an organic solvent and used as a non-aqueous electrolyte solution. Alternatively, a solid electrolyte may be used. Additionally, there are cases where the solid electrolyte acts as a separator, which will be described later, and in that case, other separators may be unnecessary.

### <Separator>

A separator may be positioned between the positive and negative electrodes. Such a separator can be in the form of a porous film, non-woven fabric, or woven fabric. Given that the volumetric energy density of the battery increases and the internal resistance decreases, the thickness of the separator is preferably small as long as mechanical strength is maintained.

### <Method of Manufacturing Lithium Secondary Battery>

A lithium secondary battery may be manufactured by stacking the positive electrode, the separator, and the negative electrode in such an order to form an electrode group, then storing the electrode group in a battery can, by rolling up the electrode group if necessary, and impregnating the electrode group with a non-aqueous electrolyte solution. Alternatively, the secondary battery may be manufactured by stacking the positive electrode, the solid electrolyte, and the negative electrode to form an electrode group, then storing the electrode group in a battery can, and rolling up the electrode group if necessary.

Hereinafter, preferred examples will be presented to aid understanding of the present disclosure. However, the following examples are only intended to aid understanding of the present disclosure and do not limit the present disclosure.

### EXAMPLES AND COMPARATIVE EXAMPLES

### Comparative Example 1

To prepare a positive electrode additive corresponding to Li₂NiₓCu_{y}O₂ (where 0≤x≤1, 0≤y≤1, and x+y=1), a pellet was obtained by mixing 1.0 mole of Li₂O and 1.0 mole of NiOH and maintaining 4 tons of pressure for 5 minutes using a pelletizer.

Then, the obtained pellet was heated to a temperature of 710° C. at a rate of 5° C. per minute in a sintering furnace, and the same temperature was maintained for 17 hours. Next, the resulting sintered product was cooled and ground to obtain a powdered Li₂NiO₂ positive electrode additive where no coating layer was formed.

### Comparative Example 2

To use CH₃[Si(CH₃)₂O]ₙOsi(CH₃)₃ (where n is an integer in a range of 1 to 1000) and B₂O₃ as coating materials, PDMS and B(OH)₃ were stirred in THE in a 10:0 weight ratio and set to account for 5 wt % compared to Li₂NiO₂, core component particles. Then, the core component particles and the coating materials were stirred at a speed of 400 rpm for 1 hour to remove THE and subjected to heat treatment in a vacuum oven at a temperature of 150° C. Next, the resulting sintered product was cooled and ground to obtain a Li₂NiO₂ positive electrode additive, where a coating layer containing the hydrophobic material but free of the ion-conductive material was formed.

### Comparative Example 3

A positive electrode additive was obtained in the same manner as in Comparative Example 1, except that the PDMS: B(OH)₃ weight ratio was 3:7.

### Comparative Example 4

A positive electrode additive was obtained in the same manner as in Comparative Example 1, except that the PDMS: B(OH)₃ weight ratio was 0:10.

### Example 1

A positive electrode additive was obtained in the same manner as in Comparative Example 1, except that the PDMS: B(OH)₃ weight ratio was 7:3.

### Example 2

A positive electrode additive was obtained in the same manner as in Comparative Example 1, except that the PDMS: B(OH)₃ weight ratio was 5:5.

Hereinafter, the components of Examples 1 to 2 and Comparative Examples 1 to 4 are summarized and shown in Table 1.

TABLE 1

| | | Positive | | | | | |
|---|---|---|---|---|---|---|---|
| | Positive | electrode | PDMS | B₂O₃ | | | Heat |
| | electrode | additive weight | weight | weight | | Drying | treatment |
| | additive | (wt %) | (wt %) | (wt %) | Solvent | temperature | temperature |
| Comparative | Li₂NiO₂ | 100% | — | | — | — | — |
| Example 1 | | | | | | | |
| Comparative | Li₂NiO₂ | 95% | 5% | 0% | THF | 25° C. | 150° C. |
| Example 2 | | | | | | | |
| Example 1 | Li₂NiO₂ | 95% | 3.5% | 1.5% | THF | 25° C. | 150° C. |
| Example 2 | Li₂NiO₂ | 95% | 2.5% | 2.5% | THF | 25° C. | 150° C. |
| Comparative | Li₂NiO₂ | 95% | 1.5% | 3.5% | THF | 25° C. | 150° C. |
| Example 3 | | | | | | | |
| Comparative | Li₂NiO₂ | 95% | 0% | 5% | THF | 25° C. | 150° C. |
| Example 4 | | | | | | | |

### Experimental Example

### (1) X-Ray Diffraction (XRD) Analysis

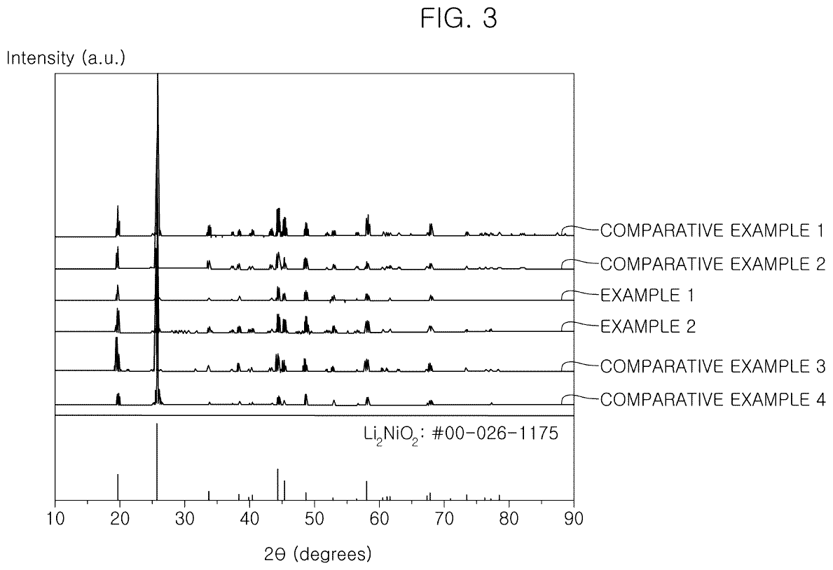

FIG. 3 shows the results of X-ray diffraction (XRD) analysis performed on Comparative Examples 1 to 4 and Examples 1 to 2. In the case of Comparative Example 1, the orthorhombic crystal structure (Immm) of existing Li₂NiO₂ was confirmed. Additionally, in the case of Comparative Examples 2 to 4 and Examples 1 to 2, the same XRD analysis results as in Comparative Example 1 were confirmed, and no additional impurities and secondary phases were formed.

### (2) Fourier-Transform Infrared Spectroscopy (FTIR) Analysis

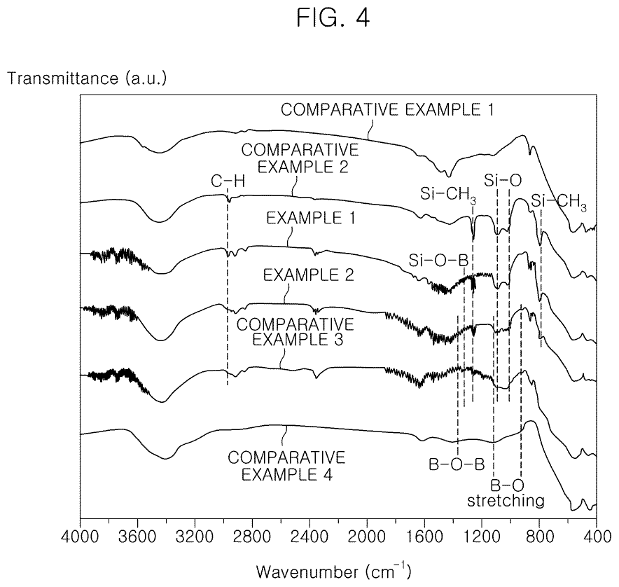

FIG. 4 shows the results of Fourier-transform infrared spectroscopy (FTIR) analysis performed on Comparative Examples 1 to 4 and Examples 1 to 2.

Unlike Comparative Example 1, in each case of Comparative Examples 2 and 4, the following peaks were confirmed: a peak in the region of 1020 to 1100 cm⁻¹ due to the covalent bond of Si and O (Si—O), a peak in the region of 910 to 1130 cm⁻¹ due to the covalent bond of B and O (BO), and a peak in the region of 1370 to 1390 cm⁻¹ due to the covalent bond of B, O, and B (BOB). Additionally, in each case of Comparative Example 3 and Examples 1 to 2, it was confirmed that the covalent bonds of Si and O (Si—O), B and O (BO), and B, O, and B (B—O—B) coexisted, and a peak in the region of 1340 cm⁻¹ due to the covalent bond of Si, O, and B (Si—O—B) was confirmed.

These results confirmed that the coating layer containing PDMS and B₂O₃ was effectively formed on the surface in the case of Comparative Examples 2 to 4 and Examples 1 to 2, where the corresponding peaks were observed.

### (3) Raman Spectrum Analysis

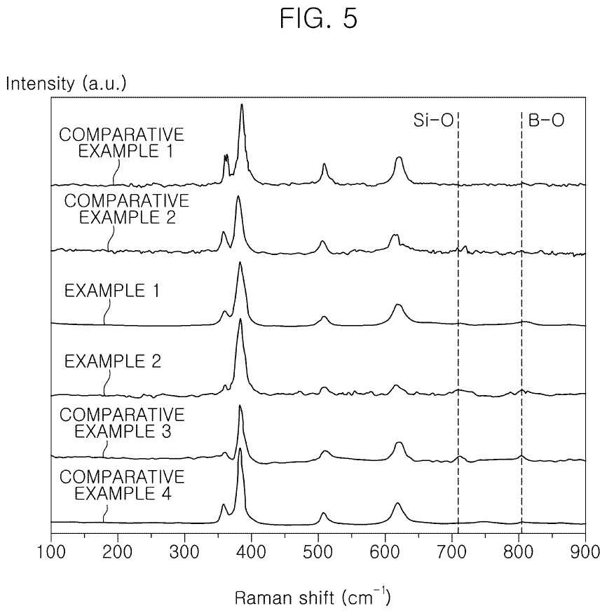

FIG. 5 shows the results of Raman spectrum analysis performed on Comparative Examples 1 to 4 and Examples 1 to 2.

Unlike Comparative Example 1, in each case of Comparative Examples 2 and 4, the following peaks were confirmed: a peak in the region of 700 to 750 cm⁻¹ due to the covalent bond of Si and O (Si—O) and a peak in the region of 780 to 820 cm⁻¹ due to the covalent bond of B and O (BO). Additionally, in each case of Comparative Example 3 and Examples 1 to 2, it was confirmed that the covalent bonds of Si and O (Si—O) and B and O (B—O) coexisted.

These results confirmed that unlike Comparative Example 1, the coating layer containing PDMS was effectively formed on the surface in the case of Comparative Example 2, and the coating layer containing PDMS and B₂O₃ was effectively formed on the surface in the case of Comparative Examples 3 to 4 and Examples 1 to 2.

### (4) X-Ray Photoelectron Spectroscopy (XPS) Analysis

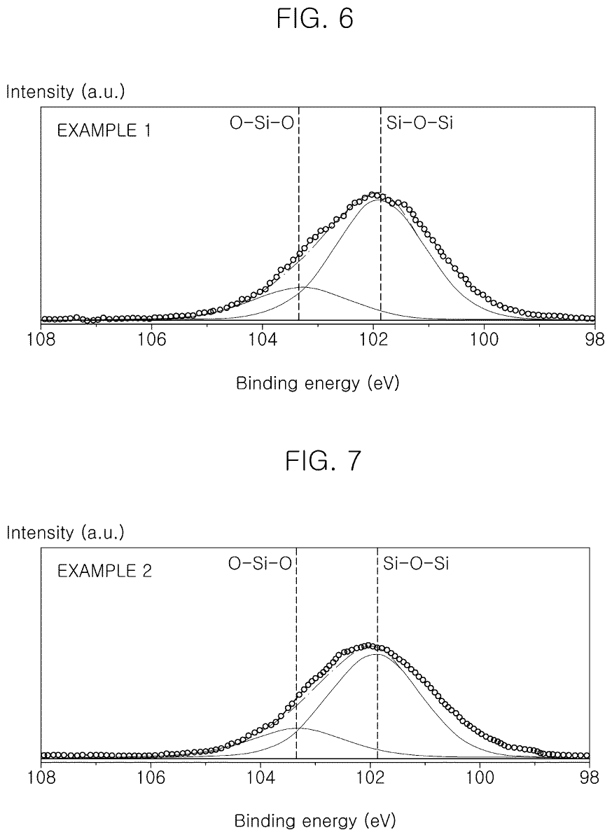

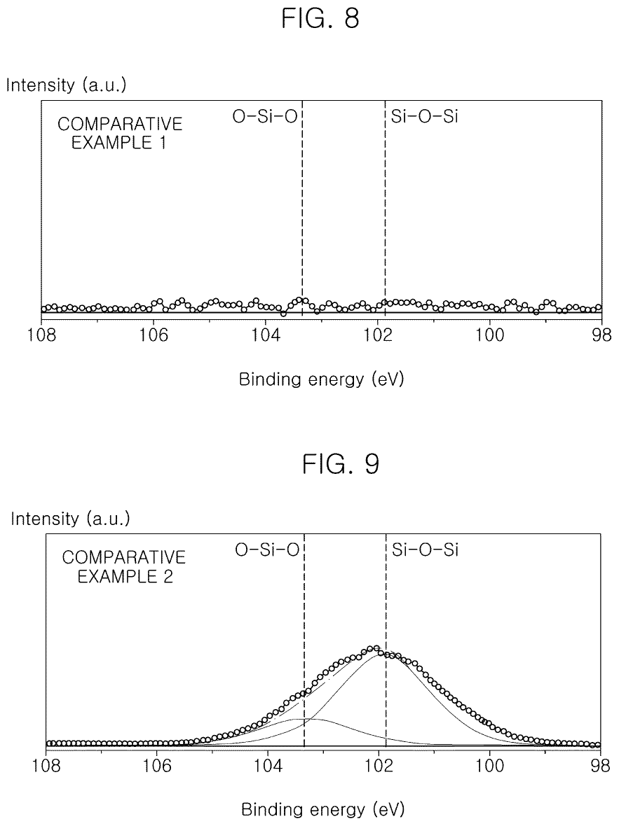

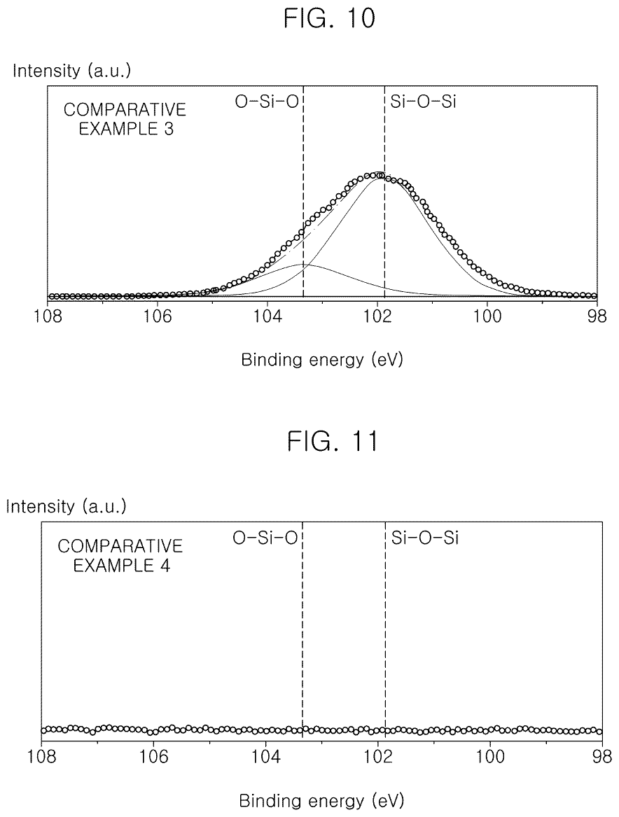

FIG. 6 to FIG. 11 show the results of X-ray photoelectron spectroscopy (XPS) analysis performed on the Si 2p regions of Comparative Examples 1 to 4 and Examples 1 to 2.

Unlike Comparative Example 1, in each case of Comparative Examples 2 to 3 and Examples 1 to 2, the following peaks were confirmed: a peak in the region of 101.7 to 101.9 eV due to the covalent bond of Si, O, and Si (Si—O—Si) and a peak in the region of 103.2 to 103.3 eV due to the covalent bond of O, Si, and O (O—Si—O).

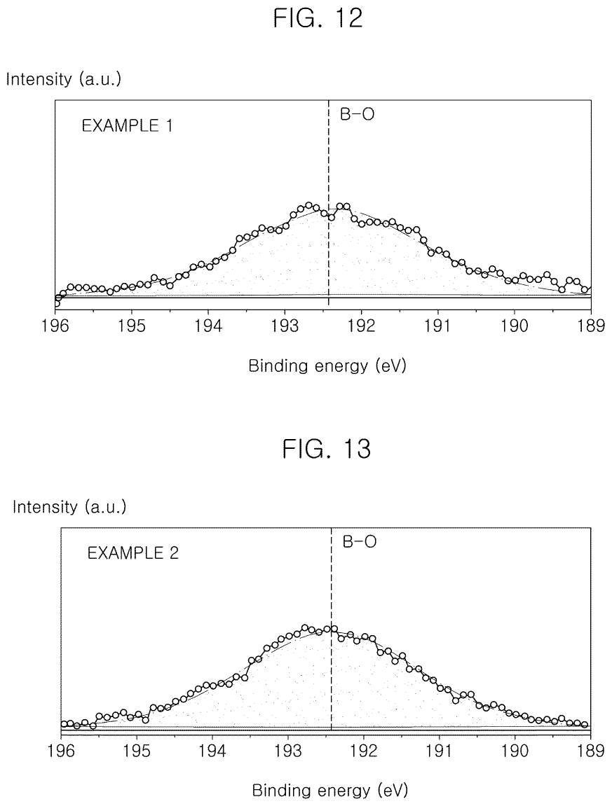

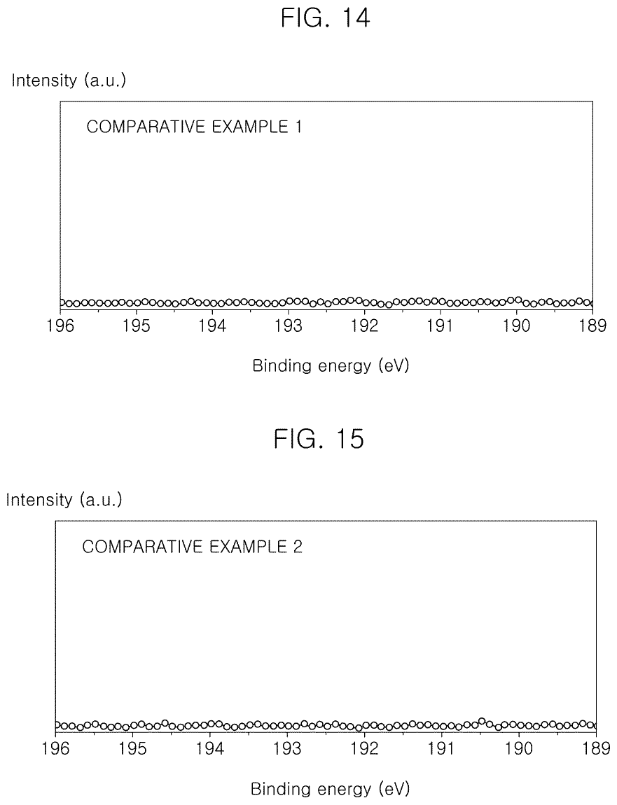

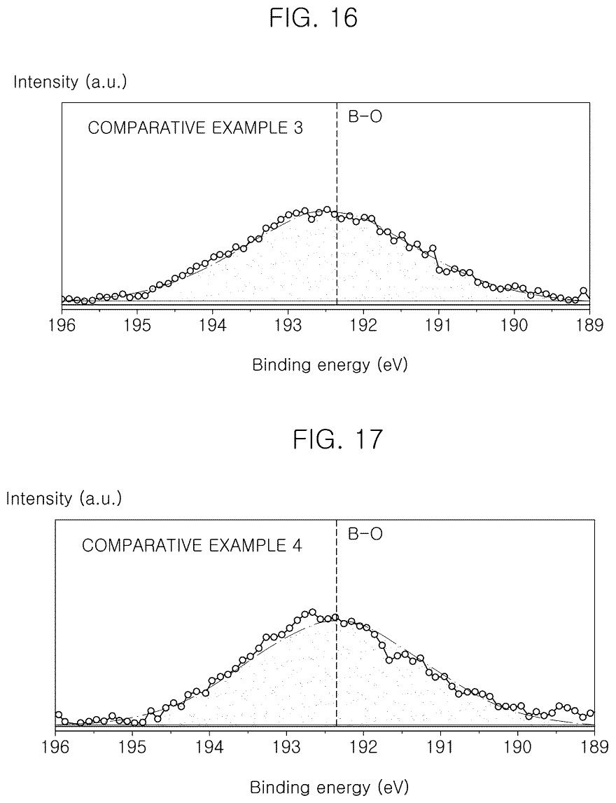

FIG. 12 to FIG. 17 show the results of XPS analysis performed on the B is regions of Comparative Examples 1 to 4 and Examples 1 to 2.

Unlike Comparative Example 1, in each case of Comparative Examples 3 to 4 and Examples 1 to 2, a peak in the region of 192.20 to 192.27 eV due to the covalent bond of B and O (B—O) was confirmed.

These results confirmed that unlike Comparative Example 1, the coating layer containing PDMS was effectively formed on the surface in the case of Comparative Example 2, and the coating layer containing PDMS and B₂O₃ was effectively formed on the surface in the case of Comparative Examples 3 to 4 and Examples 1 to 2.

### (5) Scanning Electron Microscopy (SEM) Image Analysis

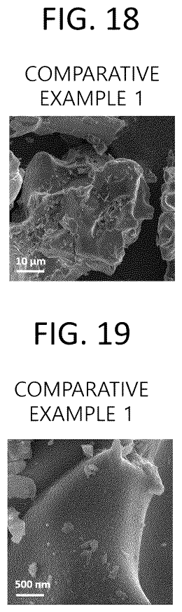

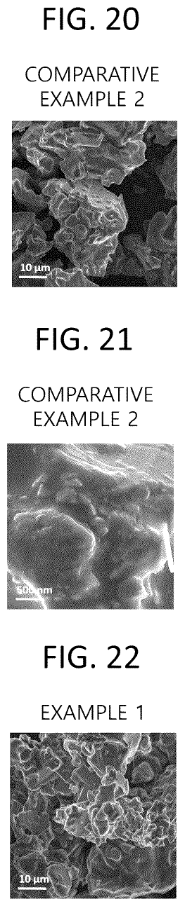

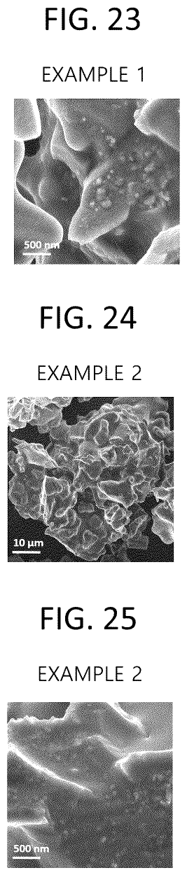

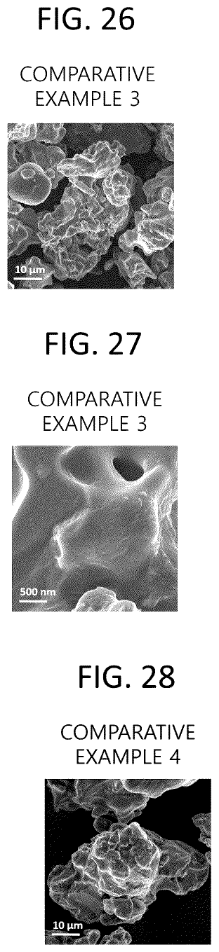

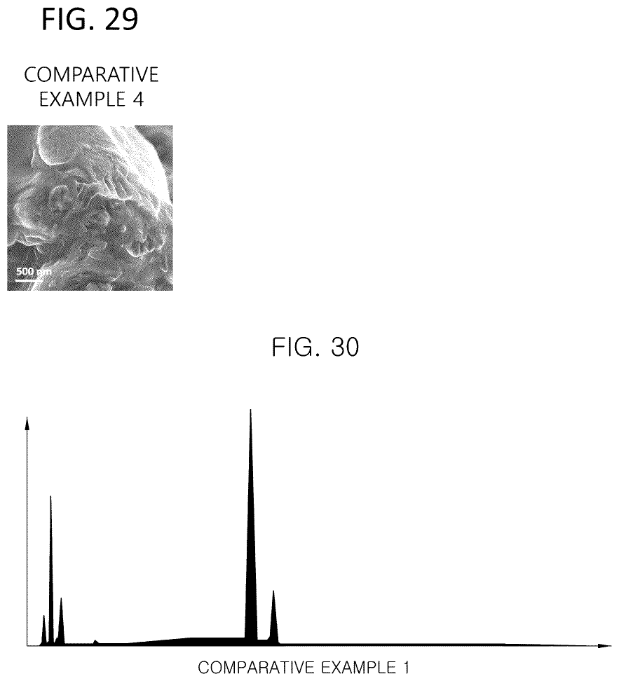

FIG. 18 to FIG. 29 are images of the materials prepared in Comparative Examples 1 to 4 and Examples 1 to 2, the images taken by scanning electron microscopy (SEM).

Unlike Comparative Example 1, it was confirmed that the uniform coating layer was formed on the surface of the positive electrode additive in the case of Comparative Examples 2 to 4 and Examples 1 to 2.

### (6) Energy-Dispersive Spectroscopy (EDS) Analysis

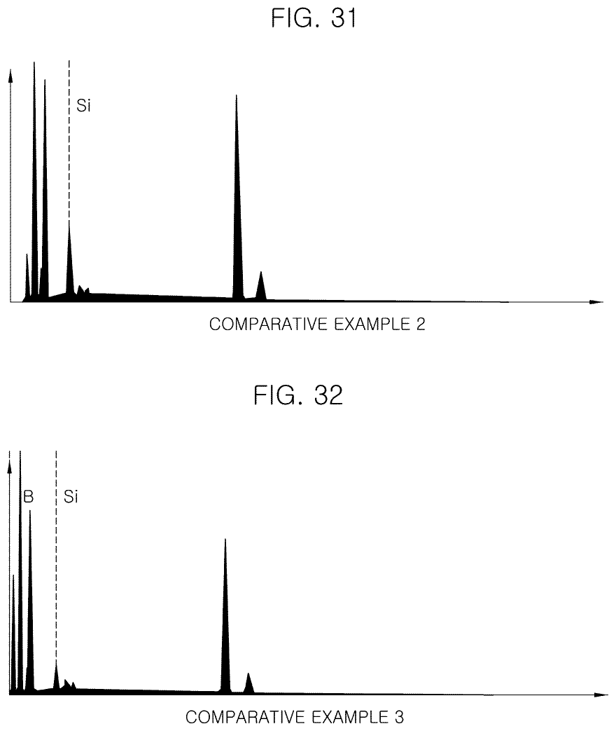

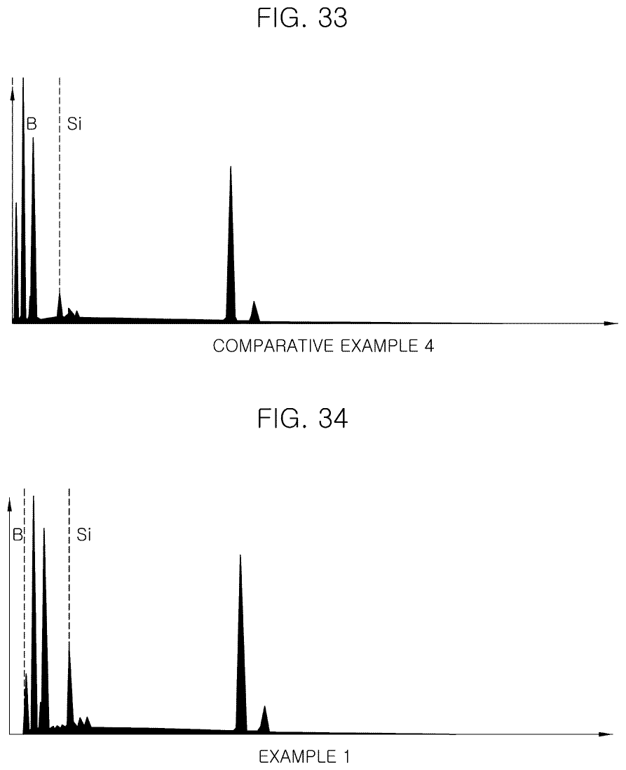

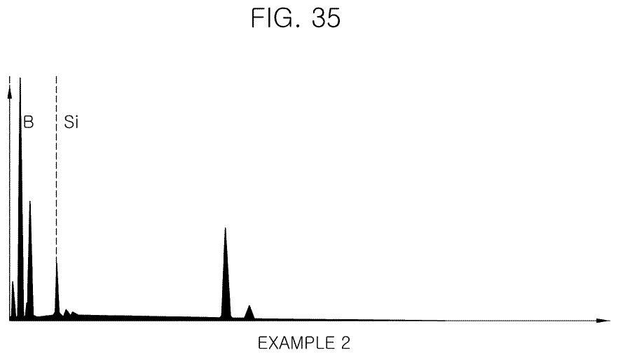

FIG. 30 to FIG. 35 show the measurement results of the distribution of Si and B elements through energy-dispersive spectroscopy (EDS) analysis performed on Comparative Examples 1 to 4 and Examples 1 to 2.

These results confirmed that unlike Comparative Example 1, the coating layer containing PDMS was effectively formed on the surface in the case of Comparative Example 2, where the peak was observable due to Si, and the coating layer containing PDMS and B₂O₃ was effectively formed on the surface in the case of Comparative Examples 3 to 4 and Examples 1 to 2, where the peaks were observable due to both B and Si. Additionally, in the case of Comparative Examples 3 to 4 and Examples 1 to 2, it was confirmed that the more the B element composition, the lower the peak of the Si element.

### (7) Manufacturing of Electrode and Battery

A positive electrode slurry was prepared by using each positive electrode additive prepared in Comparative Examples 1 to 4 and Examples 1 to 2 as a positive electrode active material, a carbon black conductive additive, a carbon-based additive, and polyvinylidene fluoride (PVDF) in a weight ratio of 93:3:1:3 to N-methylpyrrolidone (NMP) serving as a solvent. Then, aluminum foil was coated with the positive electrode slurry to a thickness of 50 m, dried, roll-pressed, and dried in vacuo at a temperature of 120° C. for 12 hours to manufacture an electrode.

The electrode manufactured above was used, and as an electrolyte, a solution in which 1 mole of LiPF₆ was dissolved in a solvent in which ethylene carbonate (EC) and ethyl methyl carbonate (EMC) were mixed in a 1:2 volume ratio was used, thereby manufacturing a typical coin cell.

### (8) Electrochemical Property Evaluation

The batteries manufactured as above were charged and discharged at a rate of 0.2 C/0.2 C by setting the voltage level during the charging and discharging to be in a range of 2.5 to 4.3 V while measuring the charge and discharge capacities. Using Equation 1 below, the capacity in the case of Comparative Example 1 and each capacity in the case of Comparative Examples 2 to 4 and Examples 1 to 2 were compared (1.0 C=320 mAh/g).

Electrochemical performance=[charge capacity in any one of Comparative Examples 2 to 4 and Examples 1 to 2/charge capacity in case of Comparative Example 1] [Equation 1]

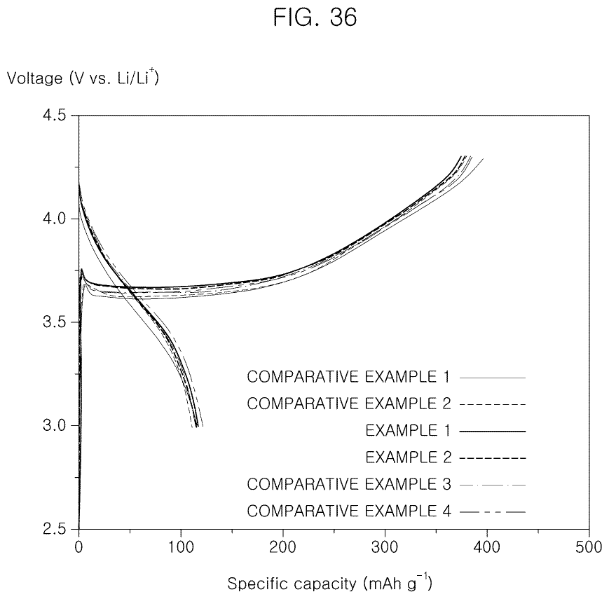

FIG. 36 is a graph showing the results of electrochemical property evaluation performed on Comparative Examples 1 to 4 and Examples 1 to 2, and the results thereof are summarized in Table 2 below.

The highest charge capacity was confirmed to be exhibited in the case of Comparative Example 1, where no coating layer was formed.

Additionally, when it comes to Comparative Examples 2 to 4 and Examples 1 to 2, where the coating layer was formed, the lowest charge capacity was exhibited in the case of Comparative Example 2, where the coating layer contained only PDMS, the hydrophobic material, and did not contain B₂O₃, the ion-conductive material. Furthermore, in the case of Examples 1 to 2 and Comparative Examples 3 to 4, where the coating layer contained B₂O₃, the charge capacity tended to increase with the amount of B₂O₃.

Additionally, it was confirmed that the charge capacity, i.e., the electrochemical performance, was 94.2% in the case of Comparative Example 2, about 95.4% in the case of Example 1, 95.3% in the case of Example 2, about 96.7% in the case of Comparative Example 3, and 96.8% in the case of Comparative Example 4, compared to Comparative Example 1.

These results confirmed that B₂03, the ion-conductive material contained in the coating layer, facilitates the entry and exit of lithium ions during the charging and discharging. This mitigates the decrease in charge capacity due to the presence of the coating layer, thereby contributing to excellent electrochemical properties.

TABLE 2

| | Charge capacity | Discharge capacity | Electrochemical |
|---|---|---|---|
| | (mAh/g) | (mAh/g) | performance (%) |
| Comparative | 397.3 | 116.1 | |
| Example 1 | | | |
| Comparative | 374.3 | 111.7 | 94.2 |
| Example 2 | | | |
| Example 1 | 379.1 | 116.4 | 95.4 |
| Example 2 | 378.5 | 115.2 | 95.3 |
| Comparative | 384.1 | 115.6 | 96.7 |
| Example 3 | | | |
| Comparative | 384.5 | 121.5 | 96.8 |
| Example 4 | | | |

### (9) Impedance Analysis

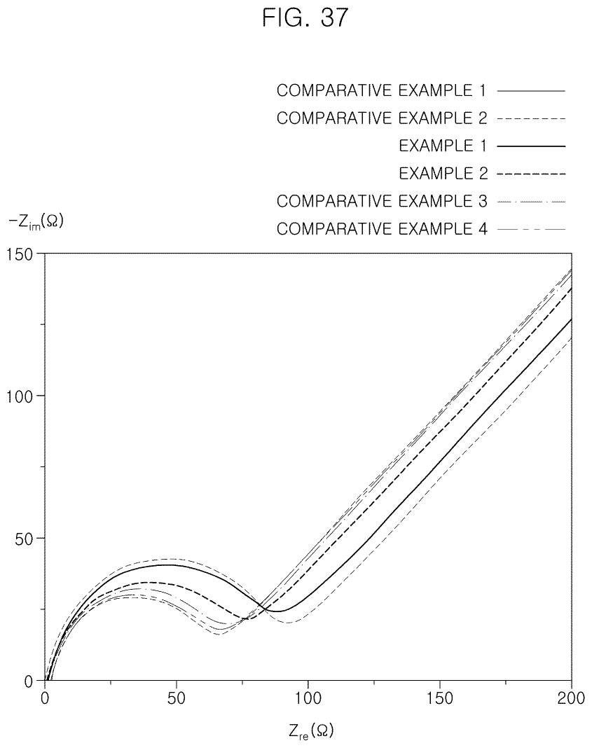

FIG. 37 is a graph showing the results of impedance analysis performed on Comparative Examples 1 to 4 and Examples 1 and 2, and the results thereof are summarized to show interfacial resistance (R_{ct}) values in Table 3.

The lowest interfacial resistance (R_{ct}) value was exhibited in the case of Comparative Example 1, where no coating layer was formed.

When it comes to Comparative Examples 2 to 4 and Examples 1 to 2, where the additive was contained to form the coating layer coating the surface of the core component, the interfacial resistance (R_{ct}) was the highest at 81.4Ω in the case of Comparative Example 2, where only PDMS, the hydrophobic material, was added. In the case of Examples 1 to 2 and Comparative Examples 1 to 2, where B₂O₃, the ion-conductive material, was contained, there was a tendency in that the higher the amount of B₂O₃, the lower the interfacial resistance (R_{ct}).

These results confirmed that due to the high ionic conductivity (up to 10⁻⁴ S/cm) of B₂O₃, the ion-conductive material present in the coating layer, the increase in the interfacial resistance due to the presence of the coating layer was effectively mitigated with the increasing amount of B(OH)₃, the precursor of B₂O₃.

TABLE 3

| | Rₛ (Ω) | R_{ct} (Ω) |
|---|---|---|
| Comparative Example 1 | 2.2 | 54.3 |
| Comparative Example 2 | 2.0 | 81.4 |
| Example 1 | 2.3 | 77.4 |
| Example 2 | 2.2 | 64.6 |
| Comparative Example 3 | 2.2 | 58.7 |
| Comparative Example 4 | 2.3 | 56.5 |

(10) Electrochemical Property Evaluation after being Left in Air

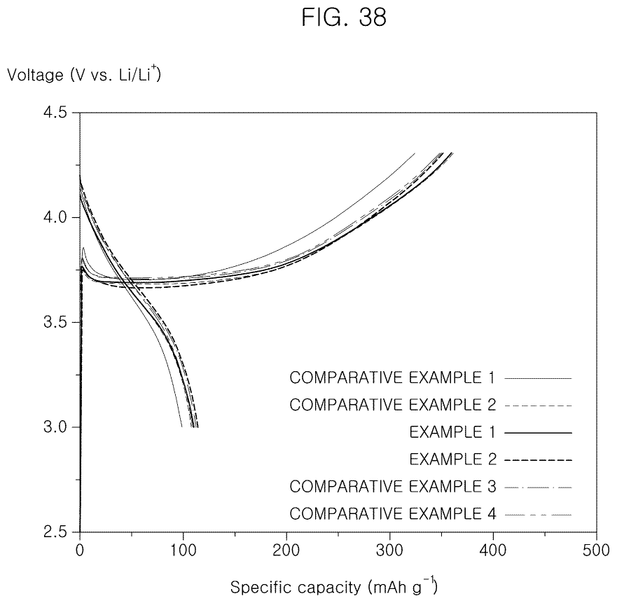

FIG. 38 shows the results of electrochemical property evaluation performed on Comparative Examples 1 to 4 and Examples 1 to 2 after being left in air at a relative humidity of 40% for 12 hours, and the results thereof are summarized in Table 4.

The lowest charge capacity was confirmed in Comparative Example 1, where the coating layer was not present. Additionally, in the cases of Comparative Examples 2 to 4 and Examples 1 to 2, where the coating layer was formed, the charge capacity decreased with the decreasing amount of PDMS, the hydrophobic material.

Furthermore, it was confirmed that the charge capacity was about 111.1% in the case of Comparative Example 2, about 110.6% in the case of Example 1, about 108.1% in the case of Example 2, 107.9% in the case of Comparative Example 3, and 107.3% in the case of Comparative Example 4, compared to the case of Comparative Example 1.

TABLE 4

| | Charge capacity | Discharge capacity | Electrochemical |
|---|---|---|---|
| | (mAh/g) | (mAh/g) | performance (%) |
| Comparative | 324.2 | 98.8 | |
| Example 1 | | | |
| Comparative | 360.5 | 108.5 | 111.1 |
| Example 2 | | | |
| Example 1 | 358.7 | 110.4 | 110.6 |
| Example 2 | 350.6 | 113.7 | 108.1 |
| Comparative | 349.9 | 112.1 | 107.9 |
| Example 3 | | | |
| Comparative | 347.9 | 108.8 | 107.3 |
| Example 4 | | | |

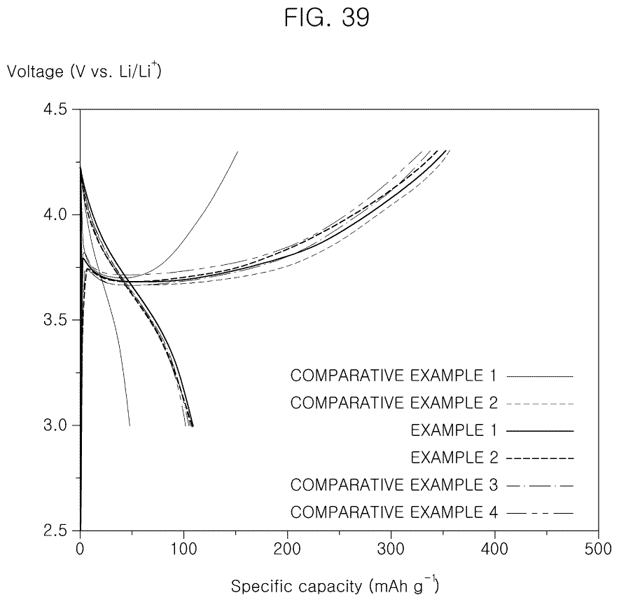

FIG. 39 shows the results of electrochemical property evaluation performed on Comparative Examples 1 to 4 and Examples 1 to 2 after being left in air at a relative humidity of 40% for 24 hours, and the results thereof are summarized in Table 5.

The lowest charge capacity was confirmed to be exhibited in the case of Comparative Example 1, where the coating layer was not present. Additionally, in the case of Comparative Examples 2 to 4 and Examples 1 to 2, where the coating layer was formed, the charge capacity decreased with the decreasing amount of PDMS.

Furthermore, it was confirmed that the charge capacity was about 223.5% in the case of Comparative Example 2, about 231.2% in the case of Example 1, about 225.7% in the case of Example 2, 221.5% in the case of Comparative Example 3, and 216.3% in the case of Comparative Example 4, compared to Comparative Example 1.

TABLE 5

| | Charge capacity | Discharge capacity | Electrochemical |
|---|---|---|---|
| | (mAh/g) | (mAh/g) | performance (%) |
| Comparative | 152.4 | 47.4 | |
| Example 1 | | | |
| Comparative | 355.8 | 105.9 | 223.5 |
| Example 2 | | | |
| Example 1 | 352.4 | 108.3 | 231.2 |
| Example 2 | 343.9 | 107.4 | 225.7 |
| Comparative | 337.5 | 103.8 | 221.5 |
| Example 3 | | | |
| Comparative | 329.7 | 101.7 | 216.3 |
| Example 4 | | | |

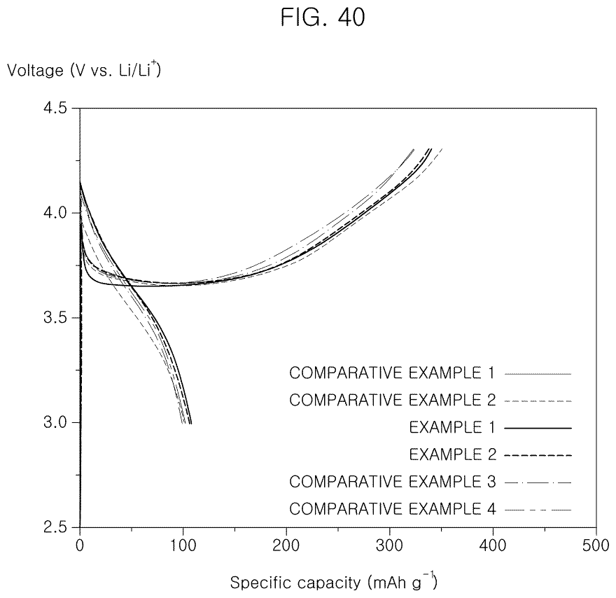

FIG. 40 shows the results of electrochemical property evaluation performed on Comparative Examples 1 to 4 and Examples 1 to 2 after being left in air at a relative humidity of 40% for 48 hours, and the results thereof are summarized in Table 6.

In the case of Comparative Example 1, where no coating layer was formed, short circuits occurred inside the cell, making the measurement of charge capacity and discharge capacity impossible.

The lowest charge capacity was observed in Comparative Example 1, where the coating layer was not present. Additionally, in the cases of Comparative Examples 2 to 4 and Examples 1 to 2, where the coating layer was formed, the charge capacity decreased with the decreasing amount of PDMS.

TABLE 6

| | Charge capacity | Discharge capacity |
|---|---|---|
| | (mAh/g) | (mAh/g) |
| Comparative Example 1 | 0 | 0 |
| Comparative Example 2 | 349.5 | 101.7 |
| Example 1 | 340.0 | 107.0 |
| Example 2 | 337.9 | 105.5 |
| Comparative Example 3 | 322.6 | 101.1 |
| Comparative Example 4 | 321.7 | 99.1 |

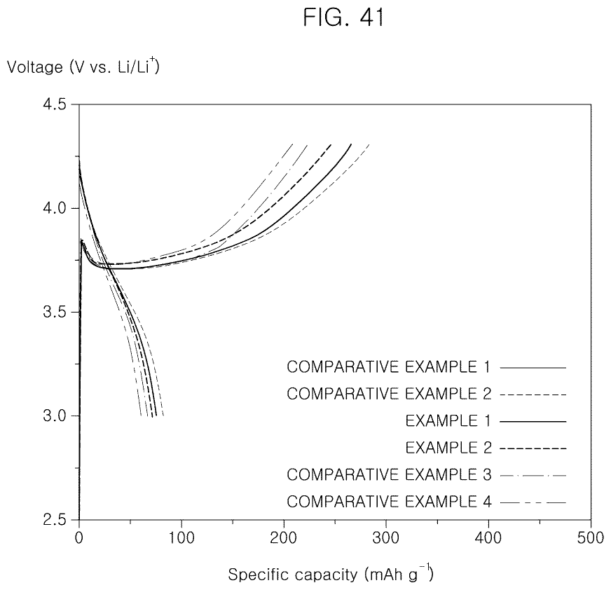

FIG. 41 shows the results of electrochemical property evaluation performed on Comparative Examples 1 to 4 and Examples 1 to 2 after being left in air at a relative humidity of 40% for 60 hours, and the results thereof are summarized in Table 7.

In the case of Comparative Example 1, where no coating layer was formed, short circuits occurred inside the cell, making the measurement of charge capacity and discharge capacity impossible.

The lowest charge capacity was observed in Comparative Example 1, where the coating layer was not present. Additionally, in the case of Comparative Examples 2 to 4 and Examples 1 to 2, where the coating layer was formed, the charge capacity decreased as the amount of PDMS decreased.

TABLE 7

| | Charge capacity | Discharge capacity |
|---|---|---|
| | (mAh/g) | (mAh/g) |
| Comparative Example 1 | 0 | 0 |
| Comparative Example 2 | 282.3 | 82.3 |
| Example 1 | 265.4 | 75.3 |
| Example 2 | 244.8 | 71.1 |
| Comparative Example 3 | 223.2 | 67.1 |
| Comparative Example 4 | 207.8 | 60.5 |

These results showed that the higher the amount of PDMS, the hydrophobic material contained in the coating layer, the better the atmospheric stability by protecting the core component from moisture in air, thus contributing to excellent electrochemical performance.

(11) XRD Analysis Measurement after being Left in Air

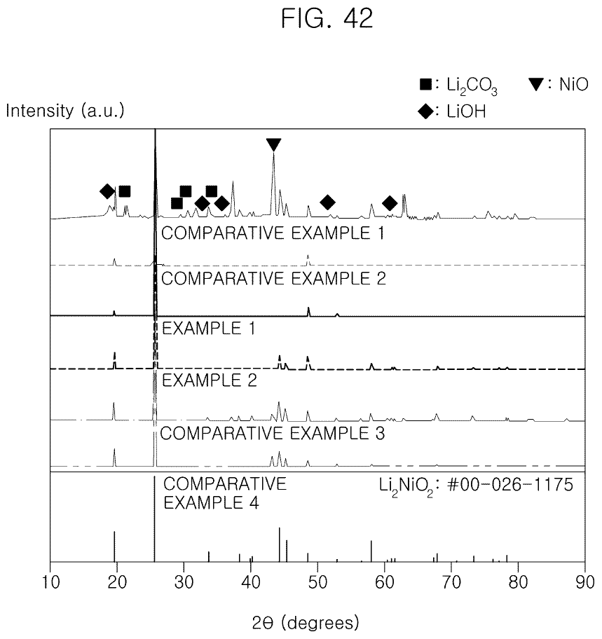

FIG. 42 shows the results of XRD analysis measurement performed on Comparative Examples 1 to 4 and Examples 1 to 2 after being left in air at a relative humidity of 40% for 48 hours, and the results thereof are summarized in Table 8.

Unlike Comparative Example 1, where no coating layer was formed, peaks due to lithium residues (LiOH and Li₂CO₃), considered impurities, were not observed in Comparative Examples 2 to 4 and Examples 1 to 2, where the coating layer was formed.

Additionally, in the case of Comparative Examples 2 to 4 and Examples 1 to 2, it was confirmed that the higher the amount of PDMS, the better the atmospheric stability, leading to a decrease in the NiO peak amount.

TABLE 8

| | NiO (%) |
|---|---|
| Comparative Example 1 | 63.8 |
| Comparative Example 2 | 7.8 |
| Example 1 | 13.5 |
| Example 2 | 18.4 |
| Comparative Example 3 | 22.9 |
| Comparative Example 4 | 26.8 |

(12) Measurement of Lithium Residues (LiOH and Li₂CO₃) after being Left in Air

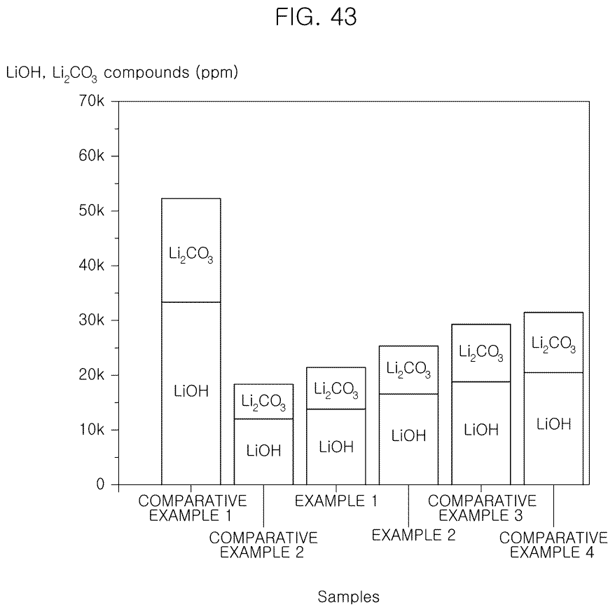

FIG. 43 shows the results of measurement performed on lithium residues (LiOH and Li₂CO₃), considered impurities, through electrochemical titration for Comparative Examples 1 to 4 and Examples 1 to 2 after being left in air at a relative humidity of 40% for 48 hours, and the results thereof are summarized in Table 9.

The proportions of LIOH were confirmed to decrease by 63.4%, 58.5%, 50.5%, 43.3%, and 38.7% in the case of Comparative Example 2, Example 1, Example 2, Comparative Example 3, and Comparative Example 4, respectively, compared to that in the case of Comparative Example 1.

Additionally, it was seen that the proportions of Li₂CO₃ decreased by 67.5%, 60.1%, 53.1%, 45.6%, and 41.6%, respectively.

These results confirmed that the higher the amount of PDMS contained in the coating layer, the fewer lithium residues (LiOH and Li₂CO₃), considered impurities, were produced.

TABLE 9

| | LiOH (ppm) | Li₂CO₃ (ppm) |
|---|---|---|
| Comparative Example 1 | 33560.1 | 18770.6 |
| Comparative Example 2 | 12283.0 | 6100.5 |
| Example 1 | 13927.4 | 7489.5 |
| Example 2 | 16622.7 | 8794.2 |
| Comparative Example 3 | 19028.6 | 10211.2 |
| Comparative Example 4 | 20572.3 | 10962.0 |

### (13) Real-Time Electrochemical Property Evaluation of PAT-Cell Gas and Gas Generation Measurement

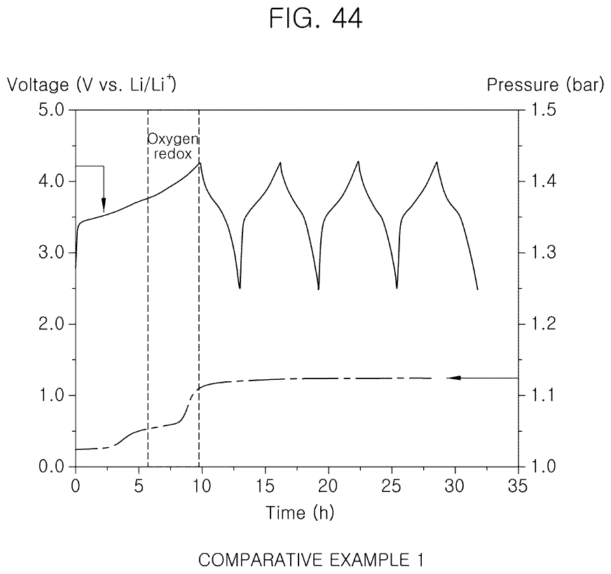

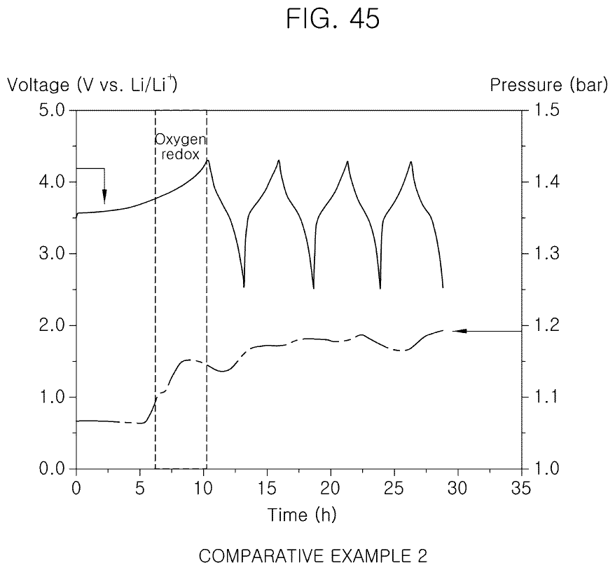

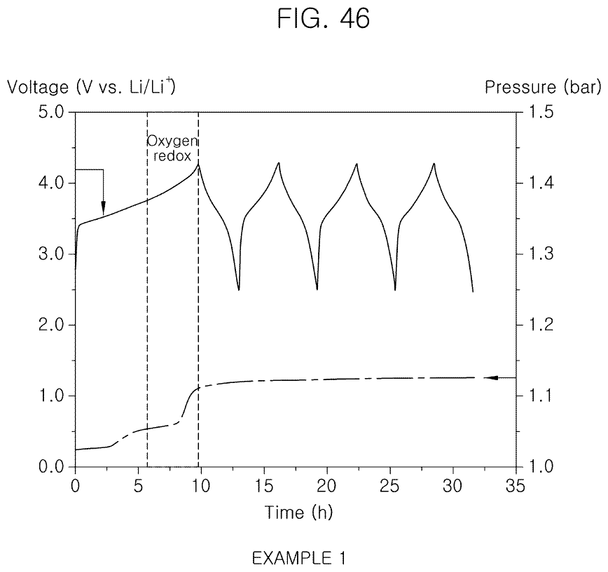

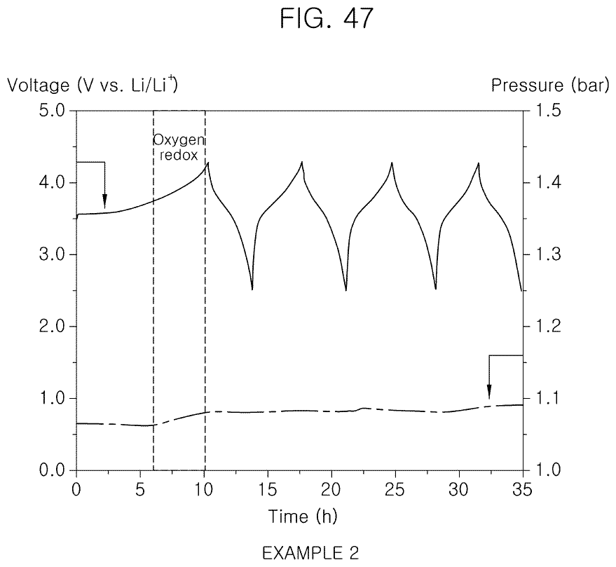

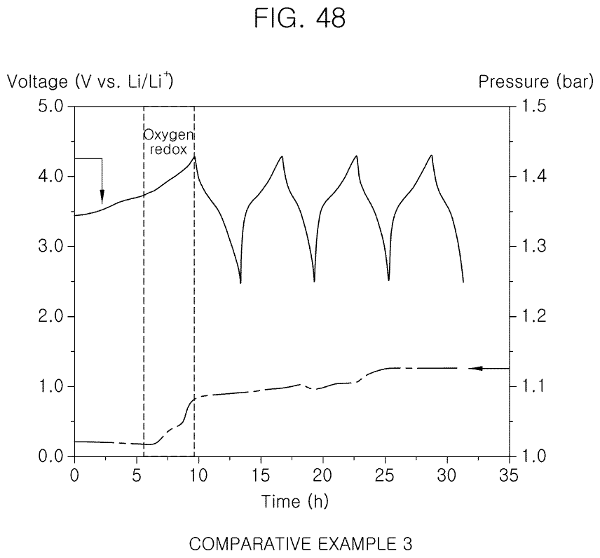

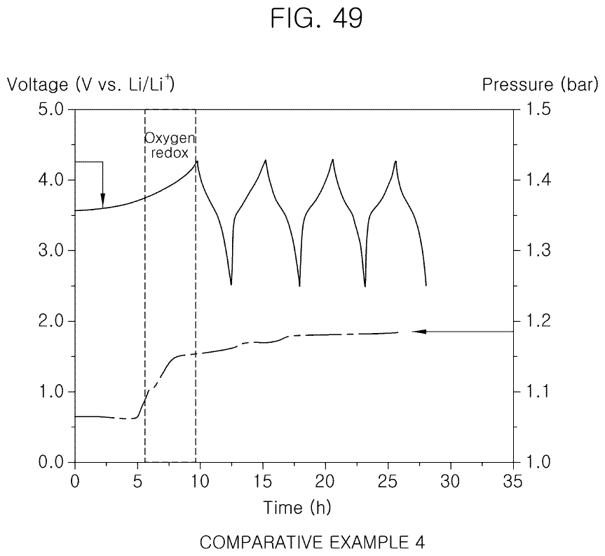

FIG. 44 to FIG. 49 show the results of real-time PAT-cell gas electrochemical property evaluation and gas generation measurement performed on Comparative Examples 1 to 4 and Examples 1 to 2.

In FIG. 44 to FIG. 49, the solid lines with repeated cycles show changes in the voltage for Comparative Examples 1 to 4 and Examples 1 and 2 according to the electrochemical property evaluation. The dashed lines represent the amount of gas generation according to the electrochemical property evaluation.

It was confirmed that the gas was kept from being generated due to the gas-trapping effect of the covalent bond of Si, O, and B (Si—O—B) in the case of Examples 1 to 2, compared to the case of Comparative Example 1. Additionally, it was confirmed that in the case of Comparative Example 3, the gas was kept from being generated due to the gas-trapping effect of the covalent bond of Si, O, and B (Si—O—B).

In the case of Comparative Example 2, although the gas was kept from being generated as PDMS was contained in the coating layer, the covalent bond of Si, O, and B (Si—O—B) failed to be formed because B₂O₃ was not contained, unlike Comparative Example 3 and Examples 1 to 2, confirming that the effect of preventing gas generation was insignificant.

In the case of Comparative Example 4, although the gas was kept from being generated with the introduction of B₂O₃ into the coating layer, the covalent bond of Si, 0, and B (Si—O—B) failed to be formed because PDMS was not contained, unlike Comparative Example 3 and Examples 1 to 2, confirming that the effect of preventing gas generation was insignificant.

These results confirmed that when the coating layer contained both PDMS and B₂O₃, the gas was effectively kept from being generated.

These experimental examples showed that the decrease in charge capacity due to the presence of the coating layer was mitigated with the increasing amount of B₂O₃, the ion-conductive material contained in the coating layer formed on the surface of the core component. Additionally, the core component may be effectively protected from moisture in air with the increasing amount of PDMS, the hydrophobic material contained in the coating layer. It was also confirmed that when the coating layer contained these two materials, the effect of preventing gas generation was the same as or greater than when either material was contained alone.

Additionally, it was confirmed through Examples 1 to 2 that when the weight ratio of B₂O₃ to PDMS, contained in the coating layer, was in a range of 7:3 to 5:5, the positive electrode additive for the lithium secondary battery of the present disclosure had all of these effects appropriately.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A positive electrode additive of a lithium secondary battery, the positive electrode additive comprising:
a core component containing lithium metal oxide; and
a coating layer comprising a hydrophobic material and an ion-conductive material, the coating layer coating a surface of the core component.

2. The positive electrode additive of claim 1, wherein the lithium metal oxide contained in the core component is a compound represented by Formula 1 and has an orthorhombic crystal structure,
Li₂NiₓCu_{y}O₂ (where 0≤x≤1, 0≤y≤1, and x+y=1). [Formula 1]

3. The positive electrode additive of claim 1, wherein the hydrophobic material contained in the coating layer is a compound represented by Formula 2,
CH₃[Si(CH₃)₂O]ₙOSi(CH₃)₃(polydimethylsiloxane, PDMS) [Formula 2]
(where n is an integer in a range of 1 to 1000).

4. The positive electrode additive of claim 1, wherein the ion-conductive material contained in the coating layer is a compound represented by Formula 3,
Me₂O₃ [Formula 3]
wherein Me is a metal element selected from the group consisting of boron (B) and aluminum (Al).

5. The positive electrode additive of claim 1, wherein the coating layer contained in the positive electrode accounts for 10 wt % or less (excluding 0 wt %) based on he total weight of the positive electrode additive.

6. The positive electrode additive of claim 1, wherein a weight ratio of the hydrophobic material represented by Formula 2 to the ion-conductive material represented by Formula 3, contained in the coating layer, is ranging from 7:3 to 5:5,
CH₃[Si(CH₃)₂O]ₙOSi(CH₃)₃(polydimethylsiloxane, PDMS) [Formula 2]
(where n is an integer ranging from 1 to 1000)
Me₂O₃ [Formula 3]
wherein Me is a metal element selected from the group consisting of boron (B) and aluminum (Al).

7. The positive electrode additive of claim 1, wherein when performing Fourier-transform infrared spectroscopy (FTIR) measurement, the positive electrode additive exhibits the following peaks: a first peak in a region of 790 to 810 cm⁻¹, a second peak in a region of 910 to 930 cm⁻¹, a third peak in a region of 1020 to 1100 cm⁻¹, a fourth peak in a region of 1110 to 1130 cm⁻¹, a fifth peak in a region of 1200 to 1250 cm⁻¹, a sixth peak in a region of 1340 cm⁻¹, and a seventh peak in a region of 1370 to 1390 cm⁻¹.

8. The positive electrode additive of claim 1, wherein when performing X-ray photoelectron spectroscopy (XPS) analysis on a B is region, the positive electrode 5 additive exhibits a third peak in a region of 292.20 to 292.27 eV.

9. The positive electrode additive of claim 1, wherein when performing XPS analysis on a Si 2p region, the positive electrode additive exhibits a first peak in a region of 101.7 to 101.9 eV and a second peak in a region of 103.2 to 103.3 eV.

10. The positive electrode additive of claim 1, wherein when performing Raman spectrum analysis, the positive electrode additive exhibits a first peak in a region of 700 to 750 cm⁻¹ and a second peak in a region of 780 to 820 cm⁻¹.

11. A method of preparing a positive electrode additive for a lithium secondary battery, the method comprising:
preparing a core component containing lithium metal oxide; and
forming a coating layer comprising a hydrophobic material and an ion-conductive material, the coating layer coating a surface of the core component.

12. The method of claim 11, wherein the lithium metal oxide contained in the core component is a compound represented by Formula 1 and has an orthorhombic crystal structure,
Li₂NiₓCu_{y}O₂ (where 0≤x≤1, 0≤y≤1, and x+y=1). [Formula 1]

13. The method of claim 11, wherein the hydrophobic material contained in the coating layer is a compound represented by Formula 2,
CH₃[Si(CH₃)₂O]ₙOSi(CH₃)₃(polydimethylsiloxane, PDMS) [Formula 2]
(where n is an integer ranging from 1 to 1000).

14. The method of claim 11, wherein the ion-conductive material contained in the coating layer is a compound represented by Formula 3,
Me₂O₃ [Formula 3]
wherein Me is a metal element selected from the group consisting of boron (B) and aluminum (Al).

15. The method of claim 11, wherein in the preparing of the core component, a pellet is obtained by applying a pressure to any one among a lithium composite metal oxide, lithium hydroxide, or a mixture thereof, and the obtained pellet is then subjected to heat treatment.

16. The method of claim 11, wherein in the forming of the coating layer, a sintered product is formed by introducing the hydrophobic material represented by Formula 2, the ion-conductive material represented by Formula 3, and the core component containing the lithium metal oxide represented by Formula 1 into a tetrahydrofuran (THF) solvent, stirring the resulting mixture, evaporating the THF solvent, and subjecting unevaporated residues to heat treatment, and then the sintered product is cooled to room temperature and ground,
Li₂NiₓCu_{y}O₂ (where 0≤x≤1, 0≤y≤1, and x+y=1), [Formula 1]
CH₃[Si(CH₃)₂O]ₙOSi(CH₃)₃(polydimethylsiloxane, PDMS) [Formula 2]
(where n is an integer ranging from 1 to 1000), and
Me₂O₃ [Formula 3]
wherein Me is a metal element selected from the group consisting of boron (B) and aluminum (Al).

17. The method of claim 11, wherein the forming of the coating layer is performed in such a manner that the coating layer contained in the positive electrode additive accounts for 0.1 to 20 wt % based on the total weight of the positive electrode additive.

18. The method of claim 11, wherein the forming of the coating layer is performed in such a manner that a weight ratio of the hydrophobic material represented by Formula 2 to the ion-conductive material represented by Formula 3, contained in the coating layer, is ranging from 7:3 to 5:5,
CH₃[Si(CH₃)₂O]ₙOSi(CH₃)₃(polydimethylsiloxane, PDMS) [Formula 2]
(where n is an integer ranging from 1 to 1000)
Me₂O₃ [Formula 3]
wherein Me is a metal element selected from the group consisting of boron (B) and aluminum (Al).

19. A lithium secondary battery comprising an additive of claim 1.

20. A vehicle comprising a battery of claim 19.
